(19) United States
(12) Patent Application Publication
(10) Pub. No.: US 2007/0012141 A1
(43) Pub. Date: Jan. 18, 2007

(54) Handle driving structure of socket wrench

(76) Inventor: Chin-Chen Huang, Taichung (TW)

Correspondence Address: RABIN & BERDO, P.C., Suite 500, 1101 14th Street, N.W., Washington, DC, 20005, US

(21) Appl. No.: 11/179,563

(22) Filed: Jul. 13, 2005

(51) Int. Cl. B25B 17/00; B25B 13/00

(52) U.S. Cl. 81/57.29; 81/58.1

(57) ABSTRACT

This invention relates to a handle driving structure of socket wrench. More specifically, the invention relates to a socket wrench which has a double torque transfer mechanism such as reciprocating stroke action and fixed point rotation. This invention improves the structure between the rotating rod and the handle in the prior art U.S. Pat. No. 6,718,850B2. A handle part is inserted and combined to one side of the head end part of the wrench body. Meanwhile, the rotating rod penetrates and is installed inside the pivoting hole slot of the handle part, and protrudes and extends to the end of the handle part. Furthermore, a T-shaped handle is connected to the end of the rotating rod.

### BACKGROUND OF THE INVENTION

1. Field of the Invention

This invention relates to an improvement for the handle driving structure of socket wrench, it is mainly to improve the handle structure of the prior art U.S. Pat. No. 6,718,850B2 “TORQUE TRANSFER MECHANISM FOR SOCKET WRENCH”, therefore, when the socket wrench is operated at fixed point for rotating torque output, it can be more convenient and smooth.

2. Description of the Prior Art

The prior art socket wrench comprises mainly a head end part formed in one piece having a handle part of appropriate length. A vertical round chamber is installed at the head end part in order to position and accommodate a rotating head. The inner walls of the chamber is installed with teeth, and the two sides of the rotating head are installed with a corresponding control piece. When right turn or left turn are affected by adjusting at the top of the rotating head, the control piece can then be moved to protrude and change at the side surface of the rotating head and get contacted with the right or left tooth installed at the inner walls of the chamber. Therefore, the rotating head in the chamber of the head end part can then output the torque in right or left direction in order to fix or loosen the bolt. In fact, in the rotating action to fix the bolt of the socket wrench in the prior art, the square embedded head of the rotating head is used as the torque output end, and the handle part is torque input end in the action, that is, the torque output touches vertically and downwards to the bolt and the torque input end forms a horizontal angle with it, when the palm grasps the handle part to perform a reciprocating stroke action, it is difficult to keep at certain height (an up and down irregular vibration will be seen), therefore, a stable touch of the rotating head with the bolt will be affected, and the torque output is thus unstable, certain degree of operation difficulty obviously exists; furthermore, in the initial stage of the bolt fixing, the bolt screws into the object but appropriate fixing force is not reached yet, meanwhile, the handle part is preparing for the backward stroke of next torque input, therefore, the bolt does not have fixing force to counteract on the rotating head, at this moment, the rotating head and the bolt that touches it will be moved simultaneously toward a direction that will lose their fixing force, therefore, non-smooth and difficult operations do exist in the initial stage of bolt fixing; moreover, if the bolt length is a little bit too long and appropriate fixing force is not reached yet, it will thus be difficult for the handle part to keep horizontal reciprocating action, this will in turn affect the rotating head to touch precisely the bolt and to screw it forward, the fixing operation can thus fail easily.

The current inventor wants to improve the prior art U.S. Pat. No. 6,718,850B2 “TORQUE TRANSFER MECHANISM FOR SOCKET WRENCH” targeting at the above-mentioned problem, the inside of the handle part of the prior art socket wrench is installed with a pivoting hole slot which penetrates into the round chamber of the head end part, an open chamber is formed at the crossing part of the chamber and the pivoting hole slot in order to accommodate an oblique gear; a handle and a rotating rod are molded and combined, a dented flash slot of appropriate depth is formed on the front end of the handle and peripheral surface of the rotating rod, when the handle penetrates the pivoting hole slot of the handle by the rotating rod, the flash slot can be used to let the front end protruding column push to the chamber of the head end part, this is to facilitate the oblique gear to lock on the front end protruding column, then move the oblique gear backward to the open chamber; a ring gear which uses the dented locking slot installed at the inner walls of the axial hole accompanied with the positioning beads installed at the slot located at the inner walls of the rotating head in order to be inserted to the rotating head; when the rotating head is inserted into the chamber of the head end part, it can let the ring gear and the oblique gear inside the chamber combine with each other, it also limit the oblique gear to stay at fixed position inside the chamber; during the practical operation, handle can still keep torque output by reciprocating stroke action, meanwhile, another form of torque output with double action can be achieved through the rotating action of position point which moves the oblique gear and ring gear and finally the rotating head, this is to solve the drawback of prior art socket wrench.

The current inventor, in an embodiment of the prior art U.S. Pat. No. 6,718,850B2, thinks that the handle and rotating rod of the prior art are formed into one body in a molding process, handle is the grasp position and is the torque input end of fixed point rotation too, when the socket wrench operates in a narrow space, it is obviously very difficult to operate; to solve the above-mentioned drawback, this invention aims at improving the handle structure of prior art so that during the operation of fixed point rotation torque output, the grasp location and the rotation location is separated and located at the outmost part of the wrench, therefore, during the operation of fixed point rotation torque output, the operation is convenient and smooth.

### SUMMARY OF THE INVENTION

The improvement for the handle driving structure of socket wrench for the current invention is to let the rotating rod of the prior art be the torque input end of direct operation of fixed point rotation so that the operating person can use one hand to grasp the handle in order to control the stable contact to the bolt by the wrench, and use another hand to operate rotating rod to input rotating torque, this is the technical goal that this invention plan to achieve. That is, the improvement for the handle driving structure of socket wrench for the current invention is mainly to lengthen the handle part so that the rotating rod penetrated and installed at the pivoting hole slot of it can protrude to the end of the handle, meanwhile, at the end of the rotating rod, a T shape handle is combined, through this structure improvement, the user can use one hand to grasp the handle to control the stable contact of the wrench to the bolt, another hand grasps the T shape handle at the end of the handle in order to operate rotating rod to generate rotating torque, therefore, when the socket wrench is operating on fixed point rotation torque output, a more convenient and smoother action can be achieved.

Specific Drawing:

(1) The representative figure of current invention: FIG. 1

(2) Brief descriptions of the component symbol in the representative figure of the current invention:

10 Head end part
11 Handle
12 Chamber
14 Pivoting hole slot
15 Chamber
16 Handle part
17 Ring seat
18 Bearing
20 Rotating head
24 Positioning bead
31 Rotating rod
33 Protruding column
34 Axial lock
35 T shape handle
40 Oblique gear
50 Ring gear
53 C shape combining ring
54 Embedded slot

### BRIEF DESCRIPTION OF THE DRAWINGS

FIG. 1 is cross-sectional view of the whole assembly embodiment of the current invention.

FIG. 2 is the assembly decomposition drawing of the oblique gear and the rotating rod.

FIG. 3 is the appearance drawing of the whole assembly embodiment of the current invention.

### DETAILED DESCRIPTION OF THE PREFERRED EMBODIMENT

In order to help people understanding the purpose of the current invention, a better embodiment accompanied with drawing is described as in the followings:

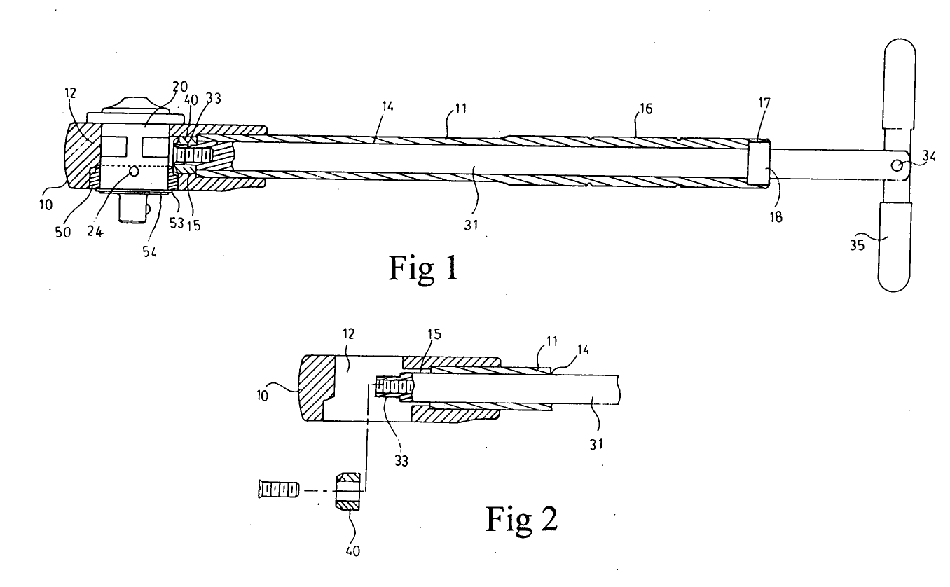

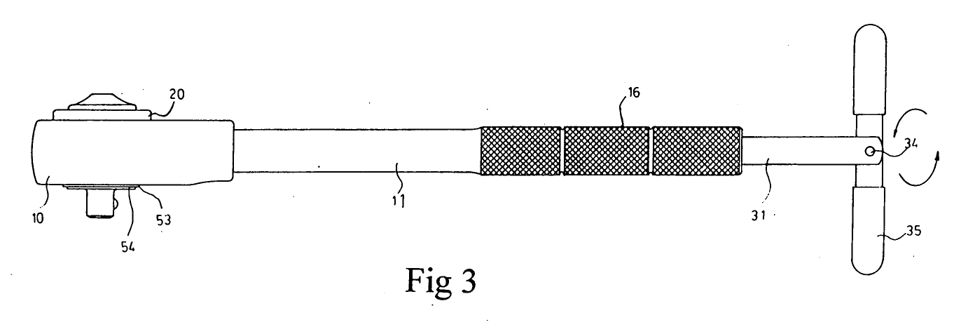

Please refer to FIGS. 1 and 2, the structure for socket wrench for the current invention is basically the same as the prior art of U.S. Pat. No. 6,718,850B2 “TORQUE TRANSFER MECHANISM FOR SOCKET WRENCH”, that is, a round chamber 12 is installed at the wrench body head end part 10, a handle part 11 installed with pivoting hole slot 14 which penetrates to the chamber 12 of the head end part 10. Meanwhile, head end part 10 forms a chamber 15 at the crossing part of the chamber 12 and the pivoting hole slot 14 of the handle part 11 to accommodate an oblique gear 40. A rotating rod 31 penetrates and is installed at the pivoting hole sot 14 of the handle part 11. The rotating rod 31 can be pushed to the chamber 12 of the head end part 10 to the oblique gear 40 to it's a front end protruding column 33 of the rotating rod. Then the oblique gear 40 is moved to the inside of chamber 15. A rotating head 20 is inserted into the chamber 12 from the top surface of head end part 10. A ring gear 50 is inserted on the rotating head 20 from the bottom of the chamber 12. A positioning bead 24 is disposed in between a slot of rotating head 20 and a locking dented slot of ring gear 50. A C shape combination ring 53 is embedded and clamped in an embedded slot 54 of the rotating head 20. Therefore, the rotating head 20 can be assembled to the chamber 12 of the head end part 10 of wrench body, and the ring gear 50 is connected to it, and can closely touch oblique gear 40. Thus, the oblique gear 40 can be limited to stay constantly inside the chamber 15 of the chamber 12. Therefore, a socket wrench which has double torque transfer mechanism such as horizontal reciprocating stroke torque output and rotating torque output is provided. The main technical features of the current invention are:

Please refer to FIG. 1, 3, a which show the handle part 11 of appropriate length. The handle part 11 has anti-slippery marks 16 formed at the outer edge end. The inside of the handle part 11 is installed with the penetrated pivoting hole slot 14 having an outer diameter slightly less than the inner diameter of the chamber 15 of the head end part 10. The handle part 11 is inserted, combined and fixed to one side edge of the head end part 10 by its front end so that the pivoting hole slot 14 inside it is connected to the chamber 15 of the head end part 10. The end of the pivoting hole slot 14 is installed with a ring seat 17 to accommodate a bearing 18. The rotating rod 31 having a length longer than that of the handle part 11 penetrates and is installed at the pivoting hole slot 14 of the handle part 11. Moreover, the front end protruding column 33 of the rod 31 can be located inside the chamber 12 of the head end part 10 to facilitate the locking of oblique gear 40 to the chamber. The end of rotating rod 31 is connected with a T-shaped handle 35 through axial lock 34. Through the improvement for the handle driving structure based on the above technical content, the users can use their palm to grasp the handle part 16 at the end of the handle part 11 in order to perform torque output having horizontal reciprocating stroke action, or use one hand to grasp the handle part 16 at the end of the handle part 11 to control a stable touch of the wrench to the bolt, while another hand operates the rotating rod 31 at the T-shaped handle 35 so that a rotating torque output is generated inside the handle part 11. Simply speaking, when the socket wrench is used in a narrow space to loosen or tighten a bolt using a fixed point rotating torque output, a more convenient and smoother operation can be expected as compared to the prior art. However, the above-mentioned is only a better embodiment of the current invention. It is not used to limit the application scope of the current invention. Any equivalent change and modification can be made without departing from the spirit of the claims of the current invention, and should still fall within the scope of the claims of the current invention.

Symbol descriptions

10 Head end part
11 Handle part
12 Chamber
14 Pivoting hole slot
15 Chamber
16 Handle part
17 Ring seat
18 Bearing
20 Rotating head
24 Positioning bead
31 Rotating rod
33 Protruding column
34 Axial lock
35 T shape handle
40 Oblique gear
50 Ring gear
53 C shape combination ring
54 Embedded slot

1. (canceled)

2. A socket wrench having a double torque transfer mechanism that provides both reciprocating stroke action and fixed point rotation, comprising:
a wrench body head end part having a first chamber, and a second chamber in communication with the first chamber;
a rotating head disposed in the first chamber;
an oblique gear that engages with the rotating head; and
a handle driving structure, including:
a handle part having an anti-slip mark section disposed at an outer edge end thereof, and having a pivoting hole slot formed therein, an outer diameter of a first end of the handle part being larger than an inner diameter of the second chamber of the head end part, the first end of the handle part being inserted in the second chamber;
a bearing inserted in a ring seat formed in the pivoting hole slot at a second end of the handle part;
a rotating rod having a length longer than that of the handle part, and being disposed inside of the pivoting hole slot, and having a first end that protrudes from the first end of the handle part, the protruding end of the rotating rod being engaged with the oblique gear; and
a handle connected, through an axial lock, to a second end of the rotating rod to form a T shape.
